(19) United States
(12) Patent Application Publication
(10) Pub. No.: US 2017/0214040 A1
(43) Pub. Date: Jul. 27, 2017

(54) METHOD FOR PREPARING SULFUR-BASED CATHODE MATERIAL

(71) Applicants: JIANGSU HUADONG INSTITUTE OF LI-ION BATTERY CO., LTD., Suzhou (CN); TSINGHUA UNIVERSITY, Beijing (CN)

(72) Inventors: Li Wang, Beijing (CN); Fang-Xu Wu, Beijing (CN); Xiang-Ming He, Beijing (CN); Yu-Mei Ren, Beijing (CN); Yu-Ming Shang, Beijing (CN); Jian-Jun Li, Beijing (CN); Jian Gao, Beijing (CN); Yao-Wu Wang, Beijing (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/482,024

(22) Filed: Apr. 7, 2017

Related U.S. Application Data
(63) Continuation of application No. PCT/CN2014/095590, filed on Dec. 30, 2014.

(30) Foreign Application Priority Data
Oct. 9, 2014 (CN) 201410527011.5

(51) Int. Cl. H01M 4/1399; H01M 10/0525; C08F 120/44; H01M 4/60

(52) U.S. Cl. CPC H01M 4/1399; H01M 4/604; H01M 10/0525; C08F 120/44; H01M 2004/028

(57) ABSTRACT

A method for preparing sulfur-based cathode material is disclosed. First, polyacrylonitrile and sulfur according to a proportion are dissolved in a first solvent at a first temperature to obtain a first solution. Second, the first solution is transferred into a second solvent at a second temperature, to precipitate the polyacrylonitrile and sulfur to form a precipitated material. Third, the precipitated material is filtered and heated to produce a sulfurized polyacrylonitrile.

### CROSS-REFERENCE TO RELATED APPLICATIONS

This application claims all benefits accruing under 35 U.S.C. §119 from China Patent Application No. 201410527011.5, filed on Oct. 9, 2014 in the State Intellectual Property Office of China, the content of which is hereby incorporated by reference. This application is a continuation under 35 U.S.C. §120 of international patent application PCT/CN2014/095590 filed on Dec. 30, 2014, the content of which is also hereby incorporated by reference.

### FIELD

The present disclosure relates to methods for preparing cathode material, particularly, to a method for preparing sulfur-based cathode material.

### BACKGROUND

Polyacrylonitrile (PAN) is a polymer composed of a saturated carbon skeleton having alternating carbon atoms with cyanide groups. PAN is not electrically conductive, but research shows that heating a mixture of PAN and sulfur can sulfurize the PAN in the mixture, to form a conductive sulfurized PAN. An article of “Fabrication of Li-ion battery with sulfurized polyacrylonitrile, Jian-Guo Ren et al., BATTERY BIMONTHLY, Vol. 38, No. 2, P73-P74(2008)” discloses PAN as a precursor reacting with sulfur at 300□ to fabricate sulfurized PAN, which can be used as Li-ion battery cathode material. Sulfurization and cyclization of the PAN occur during the reaction between the PAN and the sulfur, so that the sulfurized PAN is a conjugated polymer with a long term conjugated pi bond. The Li-ion battery cathode material made of the conjugated polymer with the long term conjugated pi bond has a high specific capacity.

However, because the sulfurized PAN is fabricated by heating the mixture formed by directly mixing the PAN and the sulfur, the mixing of the PAN and the sulfur is not uniform. Therefore, the specific capacity of the sulfurized PAN is relatively low.

### BRIEF DESCRIPTION OF THE DRAWINGS

Implementations are described by way of example only with reference to the attached figures.

FIG. 1 is a flow chart of one embodiment of a method for preparing a sulfur-based cathode material.

FIG. 2 is a Scanning Electron Microscope (“SEM”) image of a precipitated material obtained in Example 1 of the method for preparing the sulfur-based cathode material.

FIG. 3 is a SEM image of a precipitated material obtained in Example 2 of the method for preparing the sulfur-based cathode material.

FIG. 4 shows charge and discharge curves of a lithium ion battery having the sulfur-based cathode material in Example 1.

FIG. 5 shows specific capacity-cycle curve of the lithium ion battery having the sulfur-based cathode material in Example 1.

### DETAILED DESCRIPTION

A detailed description with the above drawings is made to further illustrate the present disclosure.

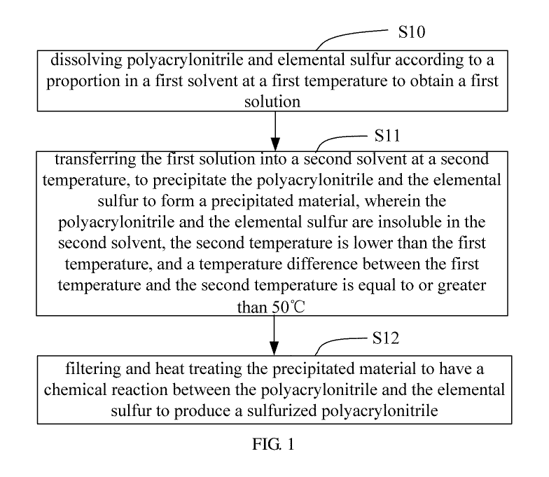

Referring to FIG. 1, one embodiment of a method for preparing sulfur-based cathode material is provided, and the method includes:

S10, dissolving polyacrylonitrile and elemental sulfur according to a proportion in a first solvent at a first temperature to obtain a first solution;

S11, transferring the first solution into a second solvent at a second temperature, to precipitate the polyacrylonitrile and the elemental sulfur to form a precipitated material, wherein the polyacrylonitrile and the elemental sulfur are insoluble in the second solvent, the second temperature is lower than the first temperature, and a temperature difference between the first temperature and the second temperature is equal to or greater than 50□; and

S12, filtering and heat treating the precipitated material to have a chemical reaction between the polyacrylonitrile and the elemental sulfur to produce a sulfurized polyacrylonitrile.

In step S10, the first temperature can be greater than or equal to 100□ and less than or equal to 200□. The sulfur and the polyacrylonitrile can be dissolved in the first solvent according to a mass ratio in a range from about 1:1 to about 10:1. A total concentration of the sulfur and the polyacrylonitrile in the first solution can be in a range from about 10 g/L to about 100 g/L. In one embodiment, the sulfur and the polyacrylonitrile can be dissolved in the first solvent according to a mass ratio in a range from about 2:1 to about 4:1. In one embodiment, the total concentration of the sulfur and the polyacrylonitrile in the first solution can be in a range from about 20 g/L to about 60 g/L. Controlling of the total concentration of the sulfur and the polyacrylonitrile in the first solution in above described range, not only facilitates the production of the precipitated material, but also facilitates the uniform mixing of the polyacrylonitrile and the elemental sulfur. The polyacrylonitrile can be a homopolymer or a copolymer of acrylonitrile monomers. A molecular weight of the polyacrylonitrile is not limited, and can be in a range from about 30,000 to about 150,000. The first solvent is not limited, and can dissolve the polyacrylonitrile and elemental sulfur. In one embodiment, the first solvent can be selected from the group consisting of N-methylpyrrolidone, dimethylformamide, dimethylsulfoxide, dimethylacetamide, and combinations thereof.

In step S11, the second temperature can be less than or equal to 50□. A volume ratio of the first solvent to the second solvent can be in a range from about 1:1 to about 1:5 to precipitate the polyacrylonitrile and the elemental sulfur out from the first solvent. The second solvent is not limited, and can be a solvent that is not capable of dissolving the polyacrylonitrile and the elemental sulfur. In one embodiment, the second solvent can be selected from the group consisting of water, ethanol, methanol, acetone, n-hexane, cyclohexane, diethyl ether, and combinations thereof. In one embodiment, the transferring of the first solution into the second solvent can be completed in 10 seconds. Thus the polyacrylonitrile and the elemental sulfur can rapidly precipitate out from the first solvent, and the polyacrylonitrile can coat on an outer surface of the elemental sulfur to form a core-shell structure. In the core-shell structure, the elemental sulfur is the core and the polyacrylonitrile forms the shell. The core-shell structure is conducive to the chemical reaction between the polyacrylonitrile and the elemental sulfur in a followed heat treating. Further, the core-shell structure is conducive to suppress heat loss during the heat treating. Furthermore, the sulfur is coated or wrapped by the polyacrylonitrile, thus the corrosion of the sulfur to a reaction device is decreased during the heat treating.

In step S12, the heat treating of the precipitated material is performed at a temperature higher than 100□. A time of the heat treating can be in a range from about 1 hour to about 10 hours. During the heat treating, a main chain similar to polyacetylene is formed by dehydrogenation of the polyacrylonitrile catalyzed by the sulfur, and the cyanide groups on a side chain are cyclized to form cyclized polyacrylonitrile. The sulfur in the core-shell structure is melted during the heat treating. The cyclized polyacrylonitrile simultaneously reacts with the melted sulfur, so that the sulfur can be embedded in the cyclized polyacrylonitrile to form the sulfurized polyacrylonitrile. The sulfurized polyacrylonitrile includes a structure unit with a molecular formula of _{C3}HNSₙ (n=1, 2, 3 . . . ). The structure unit has a structural formula of:

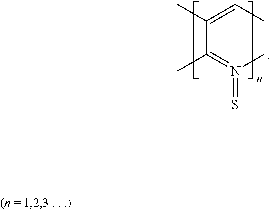

Further, the structural unit may be the main structural unit of the sulfurized polyacrylonitrile, and the sulfurized polyacrylonitrile can include other cyclized structural units.

A method for preparing sulfur-based cathode material according to one embodiment is provided, and the method includes:

S20, dissolving polyacrylonitrile and elemental sulfur according to a proportion in a first solvent at a first temperature to obtain a first solution;

S21, transferring the first solution into a second solvent at a second temperature, to precipitate the polyacrylonitrile and the elemental sulfur to form a precipitated material, wherein the polyacrylonitrile and the elemental sulfur are insoluble in the second solvent, the second temperature is lower than the first temperature, and a temperature difference between the first temperature and the second temperature is equal to or greater than 50□; and

S22, filtering and drying the precipitated material;

S23, heat treating the precipitated material to have a chemical reaction between the polyacrylonitrile and the elemental sulfur to produce a sulfurized polyacrylonitrile.

### EXAMPLES

### Example 1

8 g of sublimed sulfur and 4 g of polyacrylonitrile are weighed and added into 200 ml of dimethylformamide. The first solution is obtained until the sulfur and the polyacrylonitrile are completely dissolved in the dimethylformamide at a constant temperature oil bath at 120□. The first solution is transferred into 400 ml of deionized water at room temperature and the precipitated material is formed rapidly in 10 seconds. The precipitated material is filtered and dried. After drying, the precipitated material is heated to 400□ at which a constant temperature reaction is carried out for about 6 hours to obtain the final product.

### Example 2

8 g of sublimed sulfur and 2 g of polyacrylonitrile are weighed and added into 200 ml of dimethylformamide. The first solution is obtained until the sulfur and the polyacrylonitrile are completely dissolved in the dimethylformamide at a constant temperature oil bath at 120□. The first solution is transferred into 400 ml of deionized water at room temperature and the precipitated material is formed rapidly in 10 seconds. The precipitated material is filtered and dried. After drying, the precipitated material is heated to 400□ at which a constant temperature reaction is carried out for about 6 hours to obtain the final product.

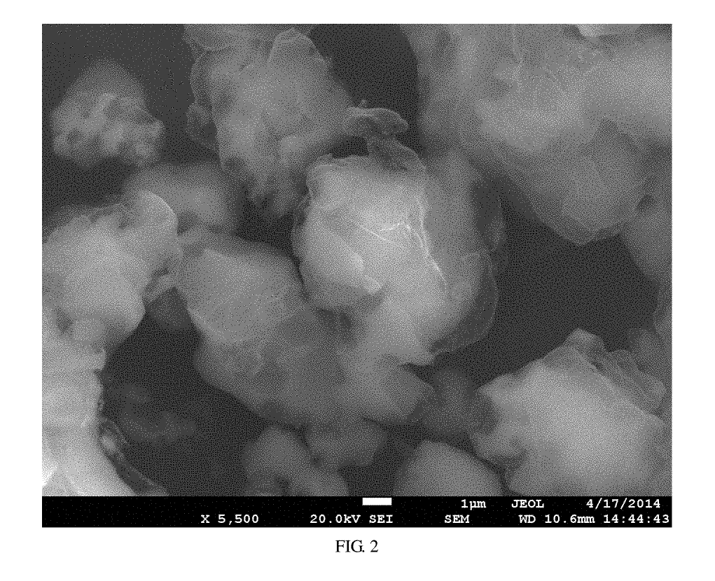

FIG. 2 is an SEM image of the precipitated material prepared in example 1. The polyacrylonitrile is uniformly coated on the outer surface of the sulfur as shown in FIG. 2.

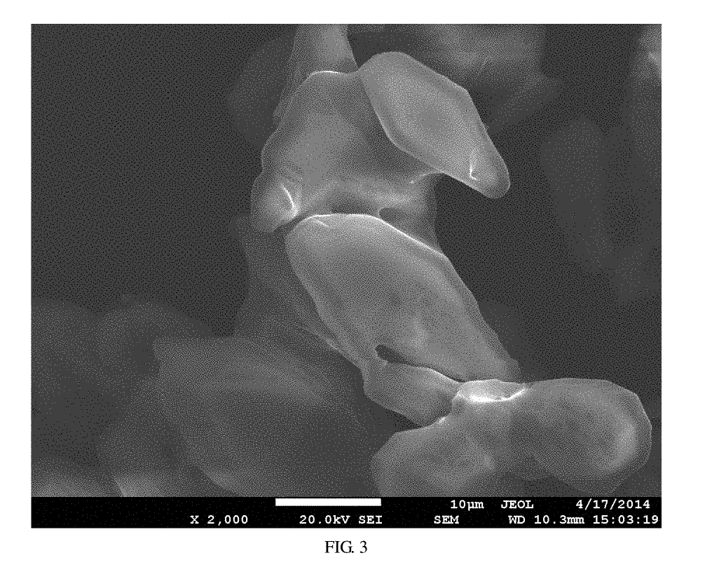

FIG. 3 is an SEM image of the precipitated material prepared in Example 2. The polyacrylonitrile is uniformly coated on the outer surface of the sulfur as shown in FIG. 2.

The sulfurized polyacrylonitrile fabricated in Example 1 can be used as a cathode active material in a lithium ion battery. 85% to 98% of the sulfurized polyacrylonitrile, 1% to 10% of a conducting agent, and 1% to 5% of a binder, by mass percent, are mixed and dispersed to form a slurry. The slurry is coated on a surface of an aluminum foil to fabricate a cathode electrode. Metal lithium is used as an anode electrode. An electrolyte is obtained by dissolving 1 mol/L lithium hexafluorophosphate (LiPF₆) in a mixed solvent of ethylene carbonate (EC) and methyl ethyl carbonate (EMC) in a volume ratio of 1:1.

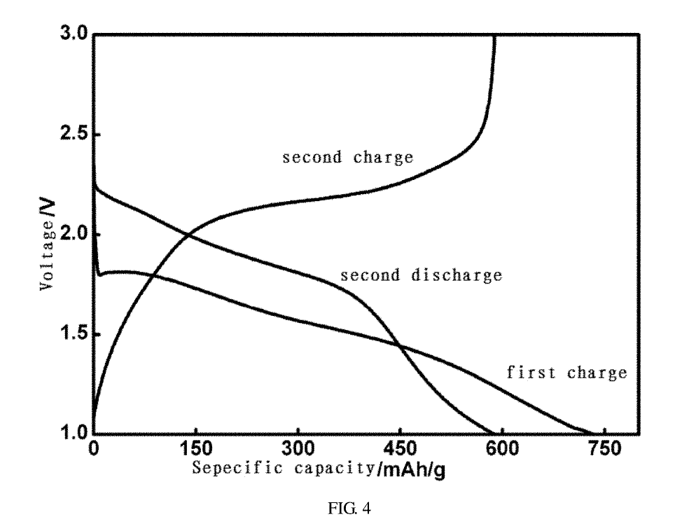

FIG. 4 illustrates a charge-discharge curve at the second cycle of the lithium ion battery. As shown in FIG. 4, a discharge specific capacity of the second cycle of the lithium ion battery reaches to 588.6 mAh/g.

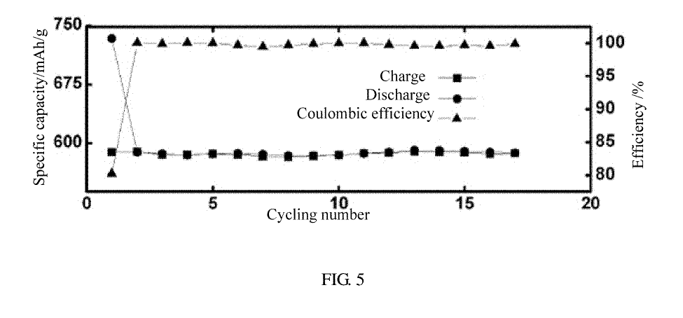

FIG. 5 is a graph showing curves of specific capacity-cycle of the lithium ion battery. As shown in FIG. 5, the specific capacity of the lithium ion battery maintains 588.3 mAh/g after 18 cycles, which shows substantially no decay. Therefore, the lithium ion battery has a perfect cycling stability.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A method for preparing sulfur-based cathode material, comprising:
dissolving polyacrylonitrile and elemental sulfur in a first solvent at a first temperature to obtain a first solution;
transferring the first solution into a second solvent at a second temperature, to precipitate the polyacrylonitrile and the elemental sulfur to form a precipitated material, wherein the polyacrylonitrile and the elemental sulfur are insoluble in the second solvent, the second temperature is lower than the first temperature, and a temperature difference between the first temperature and the second temperature is equal to or greater than 50□; and
filtering and heat treating the precipitated material to have a chemical reaction between the polyacrylonitrile and the elemental sulfur to produce a sulfurized polyacrylonitrile.

2. The method of claim 1, wherein the first temperature is greater than or equal to 100□ and less than or equal to 200□, and the second temperature is less than 50□.

3. The method of claim 1, wherein the sulfur and the polyacrylonitrile are dissolved in the first solvent according to a mass ratio in a range from about 1:1 to about 10:1.

4. The method of claim 1, wherein the sulfur and the polyacrylonitrile are dissolved in the first solvent according to a mass ratio in a range from about 2:1 to about 4:1.

5. The method of claim 1, wherein a total concentration of the sulfur and the polyacrylonitrile in the first solution is in a range from about 10 g/L to about 100 g/L.

6. The method of claim 1, wherein the first solvent is selected from the group consisting of N-methylpyrrolidone, dimethylformamide, dimethylsulfoxide, dimethylacetamide, and combinations thereof.

7. The method of claim 1, wherein the second solvent is selected from the group consisting of water, ethanol, methanol, acetone, n-hexane, cyclohexane, diethyl ether, and combinations thereof.

8. The method of claim 1, wherein a time of transferring the first solution into the second solvent is less than 10 seconds.

9. The method of claim 8, wherein in the transferring the first solution into a second solvent at a second temperature, the polyacrylonitrile coats an outer surface of the sulfur to form a core-shell structure, wherein the sulfur forms a core of the core-shell structure, and the polyacrylonitrile forms a shell of the core-shell structure.

10. The method of claim 1, wherein a volume ratio of the first solvent to the second solvent is in a range from about 1:1 to about 1:5.

11. The method of claim 1, wherein a temperature of the heat treating the precipitated material is greater than 100□, and a time of the heat treating the precipitated material is in a range from about 1 hour to about 10 hours.

12. A method for preparing sulfur-based cathode material, comprising:
dissolving polyacrylonitrile and elemental sulfur according to a proportion in a first solvent at a first temperature to obtain a first solution;
transferring the first solution into a second solvent at a second temperature, to precipitate the polyacrylonitrile and the elemental sulfur to form a precipitated material, wherein the polyacrylonitrile and the elemental sulfur are insoluble in the second solvent, the second temperature is lower than the first temperature, and a temperature difference between the first temperature and the second temperature is equal to or greater than 50□; and
filtering and drying the precipitated material;
heat treating the precipitated material to have a chemical reaction between the polyacrylonitrile and the elemental sulfur to produce a sulfurized polyacrylonitrile.

13. The method of claim 12, wherein a time of transferring the first solution into the second solvent is less than 10 seconds.

14. The method of claim 13, wherein in the transferring the first solution into a second solvent at the second temperature, the polyacrylonitrile coats an outer surface of the sulfur to form a core-shell structure, wherein the sulfur forms a core of the core-shell structure, and the polyacrylonitrile forms a shell of the core-shell structure.
